(19) United States
(12) Patent Application Publication
(10) Pub. No.: US 2026/0218560 A1
(43) Pub. Date: Jul. 30, 2026

(54) SPINDLE ARRANGEMENT FOR A CLOSURE ELEMENT, IN PARTICULAR A TAILGATE, OF A MOTOR VEHICLE

(71) Applicant: Brose Fahrzeugteile SE & Co. Kommanditgesellschaft, Bamberg, Bamberg (DE)

(72) Inventors: Michael WITTELSBÜRGER, Baunach (DE); Matthias FISCHER, Itzgrund (DE); Andreas WEIGAND, Eggolsheim (DE); Stefan FISCHER, Bamberg (DE); Jan SCHMITT, Bamberg (DE); Sven SEMBACH, Rödental (DE)

(21) Appl. No.: 19/465,699

(22) Filed: Jan. 30, 2026

(30) Foreign Application Priority Data
Jan. 30, 2025 (DE) 202025103556.1
Nov. 25, 2025 (DE) 102025148823.1

(51) Int. Cl. E05F 15/622

(52) U.S. Cl. CPC E05F 15/622; E05Y 2201/21; E05Y 2201/242; E05Y 2201/26; E05Y 2201/264; E05Y 2201/266; E05Y 2201/484; E05Y 2900/546

(57) ABSTRACT

A spindle arrangement for a closure element of a motor vehicle, wherein the spindle arrangement has a spindle-spindle nut drive with a spindle, having an axially extending geometric spindle axis, and a spindle nut meshing therewith for performing, in particular, linear displacement movements along the geometric spindle axis between a spindle-side connection and a spindle-nut-side connection, wherein the spindle is axially fixedly coupled to the spindle-side connection and the spindle nut is axially fixedly connected to the spindle guide tube, which is axially fixedly coupled to the spindle-nut-side connection, wherein the spindle arrangement has a tubular outer housing, radially enclosing the spindle-spindle nut drive, with a first housing tube and optionally a second housing tube that is capable of telescoping with the first housing tube. During a rotational movement of the spindle relative to the outer housing or to a housing-bound component in at least one spindle rotation direction.

### CROSS-REFERENCE TO RELATED APPLICATION

This application claims priority pursuant to 35 U.S.C. 119(a) to German Patent Application No. 102025148823.1, filed Nov. 25, 2025, and to German Patent Application No. 202025103556.1, filed Jan. 30, 2025, which applications are incorporated herein by reference in their entireties.

### FIELD OF THE INVENTION

The present invention relates to a spindle arrangement for a closure element, in particular a tailgate, of a motor vehicle according to the preamble of Claim 1 and to a drive arrangement for a closure element, in particular a tailgate, of a motor vehicle according to Claim 17.

### BACKGROUND

The drive arrangement in question is used in the context of the motorized displacement of any closure elements of a motor vehicle. Such closure elements can include, for example, tailgates, trunk lids, hoods, cargo compartment floors, but also doors of a motor vehicle.

The known prior art German Patent No. 10 2021 129 820 A1, upon which the invention is based, relates to a spindle arrangement for a tailgate of a motor vehicle, which has a spindle-spindle nut drive with a spindle, having an axially extending geometric spindle axis, and a spindle nut meshing therewith for carrying out, in particular, linear displacement movements along the geometric spindle axis between a spindle-side connection and a spindle-nut-side connection. The spindle is coupled in axially fixed fashion to the spindle-side connection, and the spindle nut is connected in axially fixed fashion to a spindle guide tube that is connected in axially fixed fashion to the spindle-nut-side connection. The spindle assembly also features a tubular outer housing radially enclosing the spindle-spindle nut drive and having a housing tube, which here is an outer housing tube. The spindle guide tube is capable of telescoping with the housing tube of the outer housing.

The spindle assembly, which is motorless, is located on one side of the tailgate and forms the passive side of an active/passive system. The active side, i.e., the driven side, is formed on the other side of the tailgate by a spindle drive that is motorized, i.e., has an electric drive motor. The motorless spindle arrangement allows the weight of the tailgate, which can be considerable, to be compensated for, in particular if, as in the present prior art, the spindle-side connection and the spindle-nut-side connection are pre-tensioned by a spring force into the extended position of the spindle arrangement. The aim is generally to ensure that the tailgate is always close to its equilibrium state or is pushed in the opening direction, in order to thus optimally support the spindle drive on the other side of the tailgate. One challenge in such an active/passive system is that the tailgate can fall uncontrollably when the active side is disconnected.

### SUMMARY

The invention is based upon the problem of designing and developing the known spindle arrangement in such a way that uncontrolled falling of the tailgate is prevented.

The invention relates to a spindle arrangement for a closure element of a motor vehicle, wherein the spindle arrangement has a spindle-spindle nut drive with a spindle, having an axially extending geometric spindle axis, and a spindle nut meshing therewith for performing, in particular, linear displacement movements along the geometric spindle axis between a spindle-side connection and a spindle-nut-side connection, wherein the spindle is axially fixedly coupled to the spindle-side connection and the spindle nut is axially fixedly connected to the spindle guide tube, which is axially fixedly coupled to the spindle-nut-side connection, wherein the spindle arrangement has a tubular outer housing, radially enclosing the spindle-spindle nut drive, with a first housing tube and optionally a second housing tube that is capable of telescoping with the first housing tube. It is proposed that, during a rotational movement of the spindle relative to the outer housing or to a housing-bound component in at least one spindle rotation direction, if the angular acceleration of the spindle relative to the outer housing or housing-bound component exceeds a predetermined threshold value, a switchable braking device be activated, which causes a braking of the rotational movement of the spindle.

The above object is achieved by the features of the characterizing part of claim 1.

The essential fundamental consideration is that, if necessary, as soon as the active side is disconnected, e.g., due to a breakage of the ball stud used to fix the active side to the motor vehicle, or due to an unintentional separation of the connection between the ball stud and the spindle-drive-side connection, and the entire or predominant part of the weight of the closure element rests on the passive side, a braking device is immediately activated to brake the fall and to lower the closure element slowly in a controlled manner or preferably even to hold it in a position. The braking device switches to a corresponding braking state when there is a specified acceleration, resulting from the weight force of the closure element, of the spindle in the spindle rotation direction (angular acceleration) relative to the outer housing or to a housing-bound component. The closure element may then sag slightly but is then immediately caught.

Specifically, it is proposed that, during a rotational movement of the spindle relative to the outer housing or a housing-bound component in at least one spindle rotation direction, if the angular acceleration of the spindle relative to the outer housing or housing-bound component exceeds a predetermined threshold, a switchable braking device be activated, which causes the rotational movement of the spindle to be braked.

The decisive factor for activating the braking device is therefore the acceleration of the spindle in the spindle rotation direction (angular acceleration), not its axial acceleration. The speed of the spindle in the spindle rotation direction and in the axial direction is also irrelevant here. If the spindle is accelerated slowly enough, it can rotate at a high speed and thus achieve a high displacement speed of the closure element, while the braking device remains deactivated. Only if the spindle accelerates too much in the direction of rotation will the braking device be activated and the closure element caught.

According to the particularly preferred embodiment according to claim 2, in order to activate the braking device, the inertia of a body coupled to the spindle in a torque-transmitting manner and mounted at least rotatably relative to the spindle, hereafter referred to as an inertial body, is used. This takes advantage of the effect that the spindle, as soon as it is being driven, accelerates faster than the inertial body, which accelerates less due to inertia. When the aforementioned threshold value for the angular velocity of the spindle is exceeded, a certain angular offset between the inertial body and the spindle is then reached, i.e., the inertial body is displaced relative to the spindle so much that a mechanism activates the braking device.

Claims 3 and 4 define particularly preferred options for mounting the inertial body relative to the spindle. The inertial body is, due to inertia, at least rotatable relative to the spindle, i.e., displaceable about the geometric spindle axis, but can also be displaced axially, i.e., along the geometric spindle axis, thereby activating the braking device.

Claims 5 and 6 specify how the braking device, in the activated state, preferentially brakes the rotary movement of the spindle. The braking device can thus have a brake contour and an interacting brake counter-contour, which come into contact with each other when the braking device is activated in such a way that the desired braking effect is achieved. The brake contour then experiences a torque from the spindle, whereas the brake counter-contour is assigned to the outer housing and slows down and/or stops the movement of the brake contour upon contact. This can be achieved through a frictional intervention, but particularly preferably through a blocking intervention. The relevant brake contour and/or brake counter-contour is preferably formed by a friction lining or a tooth profile, in particular a locking tooth profile.

Claims 7 to 10 relate to a first, particularly preferred kinematics of the braking device of a spindle arrangement. Preferably, when the spindle is set into rotation and/or accelerated, the inertial body is displaced relative to the spindle exclusively rotationally about the geometric spindle axis. This displacement can then be used in a simple way to generate a radial braking effect, i.e., a radial braking or blocking engagement between the brake contour and the brake counter-contour.

Claims 11 to 14 relate to a second, particularly preferred kinematics of the braking device of a spindle arrangement. Preferably, the inertial body is displaced relative to the spindle when the spindle is set into rotation and/or accelerated, both rotationally about the geometric spindle axis and linearly along the geometric spindle axis, in particular in a helical manner. This displacement can then be used in a simple way to generate an axial braking effect, i.e., an axial braking or blocking engagement between the brake contour and the brake counter-contour.

In the particularly preferred embodiment according to Claim 15, the brake counter-contour is formed on a brake housing of the braking device or on the outer housing of the spindle arrangement. These components are usually already provided, so that the brake counter-contour can be provided in a particularly simple way.

Claim 16 relates to a return arrangement for the inertial body. This has the advantage that the inertial body is returned to its starting position after its inertial displacement, thereby deactivating the braking device. However, the return mechanism also allows the inertial body to be displaced in a controlled manner, i.e., it only reaches its braking position when this is desired or necessary, in particular when the closure element suddenly and unintentionally sags.

According to a further teaching according to Claim 17, which has independent significance, a drive arrangement is claimed for a closure element, in particular a tailgate, of a motor vehicle, having a proposed spindle arrangement and a motor drive for displacing the closure element, in particular a spindle drive. The spindle arrangement then represents in particular the passive side, and the motor drive in particular the active side, of the drive arrangement.

Reference is made to all the statements relating to the proposed motor vehicle lock arrangement.

### BRIEF DESCRIPTION OF THE DRAWINGS

In the following, the invention is explained in more detail with reference to a drawing that merely represents exemplary embodiments. In the drawing:

FIG. 1 shows the rear region of a motor vehicle with a proposed drive arrangement, which is equipped with a proposed spindle arrangement;

FIG. 2 shows the spindle arrangement according to FIG. 1 in a) a retracted position and b) an extended position;

FIG. 3 shows a first exemplary embodiment of a braking device of the spindle arrangement of FIG. 1 in a) a longitudinal section view, b) a cross-sectional view with the braking device deactivated, and c) a cross-sectional view with the braking device activated;

FIG. 4 shows the braking device from FIG. 3 in a) an exploded view with a first embodiment of a housing-bound component as a brake housing and b) a second embodiment of the housing-bound component as a brake housing;

FIG. 5 shows a second exemplary embodiment of a braking device of the spindle arrangement from FIG. 1 in a) a longitudinal section view with the braking device deactivated, b) a cross-sectional view with the braking device deactivated, c) a longitudinal section view with the braking device activated, and d) a cross-sectional view with the braking device activated;

FIG. 6 shows the braking device of FIG. 5 in an exploded view;

FIG. 7 shows a third exemplary embodiment of a braking device of the spindle arrangement of FIG. 1, with only a partial representation of the brake housing, in a) a cross-sectional view with the braking device deactivated and b) a longitudinal section view with the braking device deactivated; and,

FIG. 8 shows the braking device of FIG. 7, with only a partial representation of the brake housing, in a perspectival view.

### DETAILED DESCRIPTION OF THE INVENTION

The proposed drive arrangement 1 serves for the motorized displacement of a closure element 2 of a motor vehicle 3. The closure element 2 is displaceable in an opening direction and/or in a closing direction of the closure element 2 by means of the drive arrangement 1.

The closure element 2 is here preferably a tailgate of the motor vehicle 3. The proposed drive arrangement 1 can be used particularly advantageously in the application case of a tailgate, since tailgates have a comparatively high weight.

In principle, the proposed drive arrangement 1 can, however, also be applied to other types of closure elements 2 of a motor vehicle 3. These include trunk lids, hoods, or similar items, but also doors. All statements apply according to other closure elements 2.

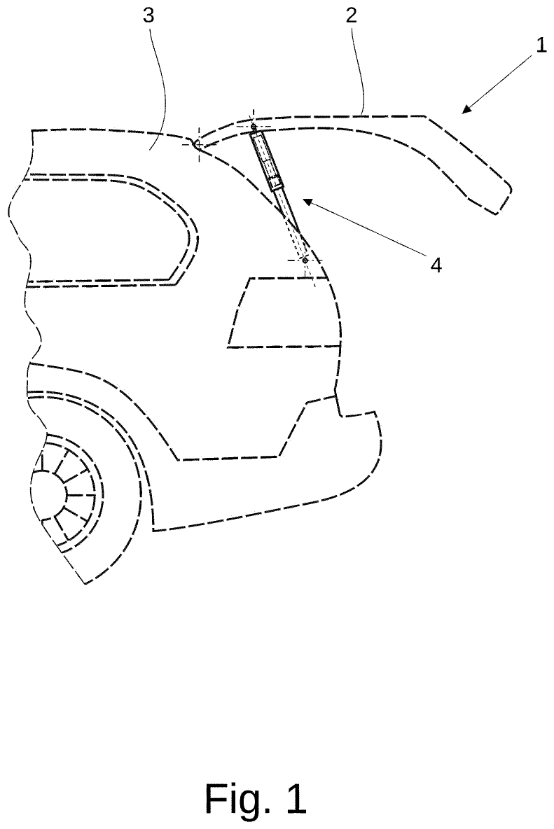

As shown in FIG. 1, the proposed drive arrangement 1 here preferably has a motorized drive, here in the form of a spindle drive, and a motorless spindle arrangement 4. The motor drive here forms the active side of an active/passive system, and the spindle arrangement 4 forms the passive side of the active/passive system. The spindle arrangement 4 here does not have its own drive but provides a spring function. The spindle arrangement 4 is intended to absorb part of the weight of the closure element 2 and thereby to keep the closure element 2, when it is open, near the equilibrium state or to push it in the opening direction.

The spindle arrangement 4 has a spindle-spindle nut drive 5 with a spindle 7, having an axially extending geometric spindle axis 6, and a spindle nut 8 meshing therewith for performing, in particular, linear displacement movements along the geometric spindle axis 6 between a spindle-side connection 9 and a spindle-nut-side connection 10. The spindle 7 is axially fixedly coupled to the spindle-side connection 9, and the spindle nut 8 is axially fixedly connected to a spindle guide tube 11, which is axially fixedly coupled to the spindle-nut-side connection 10.

The term “axial” here always relates to the geometric spindle axis 6; that is, “axial” denotes the direction along the geometric spindle axis 6.

The motor drive, which is designed here as a spindle drive, here preferably has the same structure previously specified, with the difference that the spindle drive also includes a drive motor, whereas the spindle arrangement 4 does not have a drive motor.

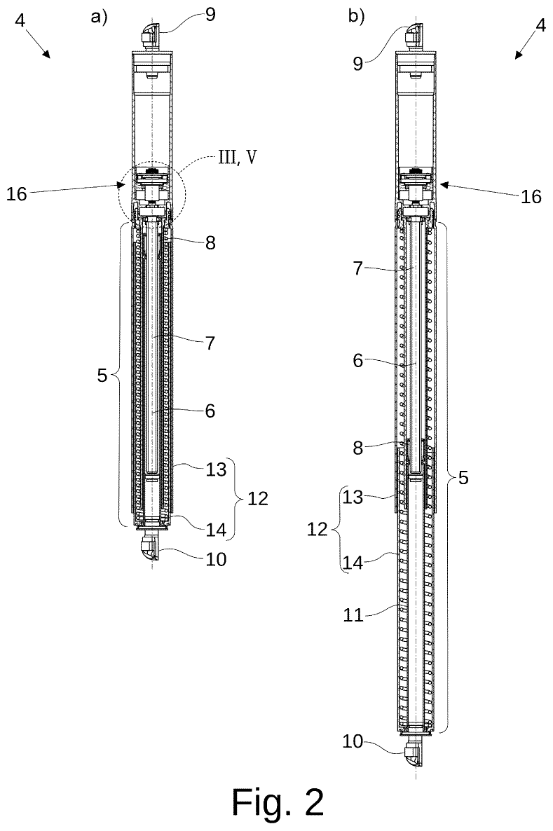

Both the spindle arrangement 4 and the motor drive can be additionally spring pre-tensioned along the geometric spindle axis 6 as shown in FIG. 2, in particular in the extended position according to FIG. 2b).

The spindle arrangement 4 also has a tubular outer housing 12, radially enclosing the spindle-spindle nut drive 5, with a first housing tube 13, in particular a housing outer tube, and optionally a second housing tube 14, in particular a housing inner tube, which can telescope with the first housing tube 13.

The term “radial” here always relates to the geometric spindle axis 6; that is, radial denotes the direction orthogonal to the geometric spindle axis 6.

The relevant exemplary embodiment shown in the figures, and which is preferred in this respect, relates to a spindle arrangement 4 for a closure element 2, in particular a tailgate, of a motor vehicle 3, wherein the spindle arrangement 4 has a spindle-spindle nut drive 5 with a spindle 7, having an axially extending geometric spindle axis 6, and a spindle nut 8 meshing therewith for performing, in particular, linear displacement movements along the geometric spindle axis 6 between a spindle-side connection 9 and a spindle-nut-side connection 10, wherein the spindle 7 is axially fixedly coupled to the spindle-side connection 9 and the spindle nut 8 is axially fixedly connected to a spindle guide tube 11, which is axially fixedly coupled to the spindle-nut-side connection 10, wherein the spindle arrangement 4 has a tubular outer housing 12, radially enclosing the spindle-spindle nut drive 5, with a first housing tube 13, in particular an outer housing tube, and optionally a second housing tube 14, in particular an inner housing tube, that is capable of telescoping with the first housing tube 13.

It is essential here that, during a rotational movement of the spindle 7 relative to the outer housing 12, in particular one of the housing tubes 12, 13—here, the first housing tube 13—or a housing-bound component 15 in at least one spindle rotation direction, if the angular acceleration of the spindle 7 relative to the outer housing 12 or housing-bound component 15 exceeds a predetermined threshold value, a switchable, in particular mechanical, braking device 16 is activated which causes a braking of the rotational movement of the spindle 7. In particular, this is provided for the direction of rotation of the spindle 7 that corresponds to a closing movement of the closure element 2. The braking device 16 is thus activated when the flap falls. However, an activation of the braking device 16 can also be provided for both directions of rotation of the spindle 7. The spindle rotation direction here always describes the direction of the rotational movement of the spindle 7 relative to the outer housing 12.

“Housing-bound” here means that the said component 15, as will be explained further by an example, is connected to the outer housing 12, in particular to the relevant housing tube 12, 13, either in a rotationally fixed manner or, in the event of overload, in a rotationally movable manner. In particular, the housing-bound component 15 is also axially fixed to the outer housing 12, in particular to the relevant housing tube 12, 13.

In the connection with a “switchable brake,” switchable means that the brake can be selectively activated (switched on) or deactivated (switched off), instead of being constantly active. This allows for precise control of the braking function as needed.

The braking device 16 is coupled to the spindle 7 in such a way that it brakes a rotary movement of the spindle 7 when the braking device 16 is activated. If, on the other hand, the braking device 16 is deactivated, the spindle 7 is not braked by the braking device 16 or at least is braked less strongly.

The activation of the braking device 16 is determined by the angular acceleration of the spindle 7 in the spindle direction of rotation, i.e., the acceleration of the rotary motion relative to the outer housing 12 or housing-bound component 15. At the same time, it is to be noted that the activation is not triggered by centrifugal forces, so that high rotational speeds of the spindle 7 and thus high displacement speeds of the closure element 2 are enabled even when the braking device 16 is deactivated.

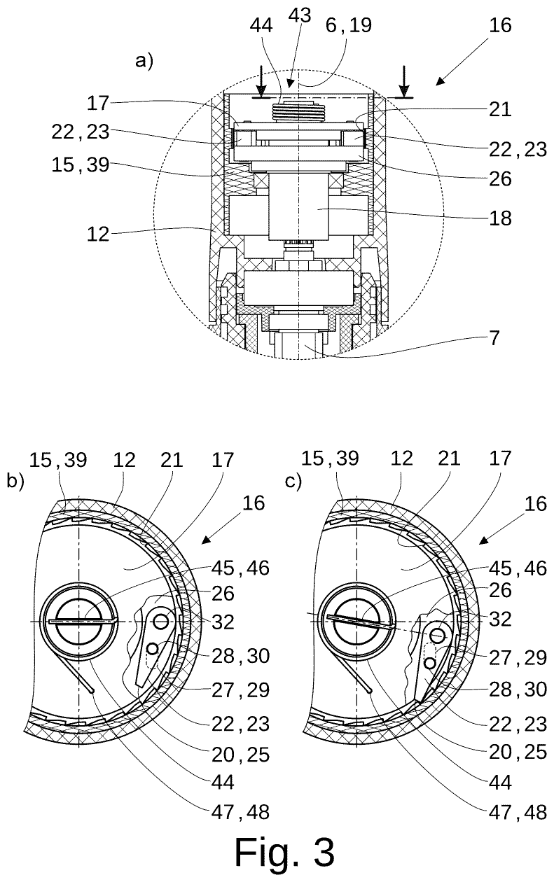

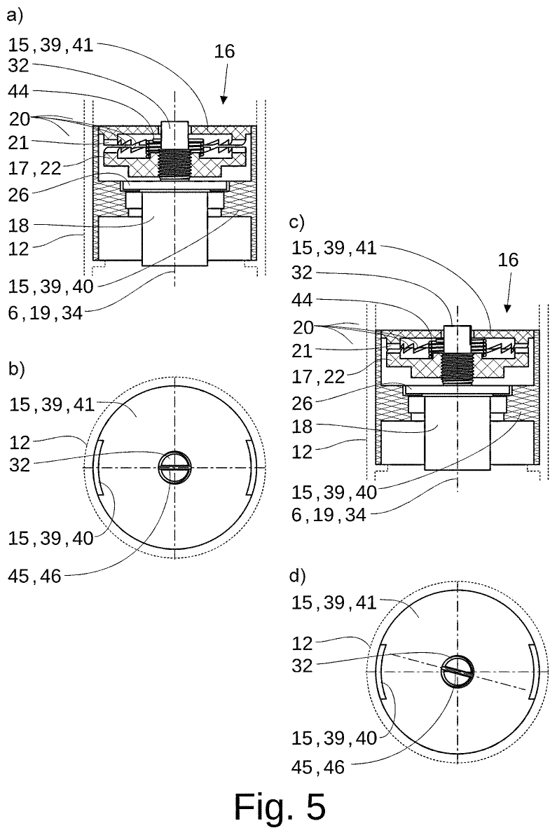

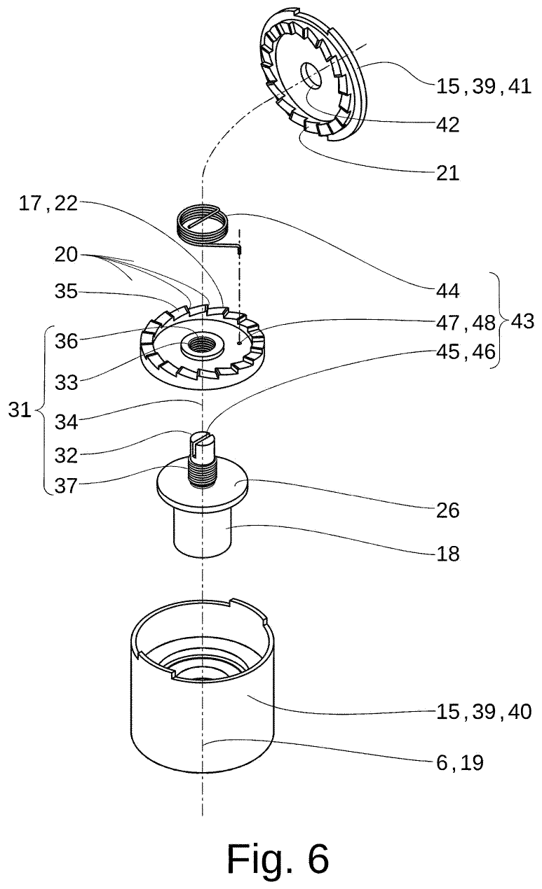

Furthermore, here, it is preferably provided that the braking device 16 has an inertial body 17 which is connected to the spindle 7 via a torque-transmitting coupling and is rotatable about the geometric spindle axis 6 relative to the spindle 7, is axially fixed according to FIGS. 3 and 4 and FIGS. 7 and 8 and is axially movable according to FIGS. 5 and 6.

“Torque-transmitting coupling” here does not mean that the two components (spindle 7 and inertial body 17) are rigidly connected to each other. Rather, this is a coupling that transmits torques at different levels depending upon the magnitude of the angular acceleration of the spindle 7. In principle, it is also conceivable that, with a comparatively low angular acceleration, no relative rotation occur between spindle 7 and the inertial body 17, and the torque therefore be transmitted in its full magnitude from the spindle 7 to the inertial body 17.

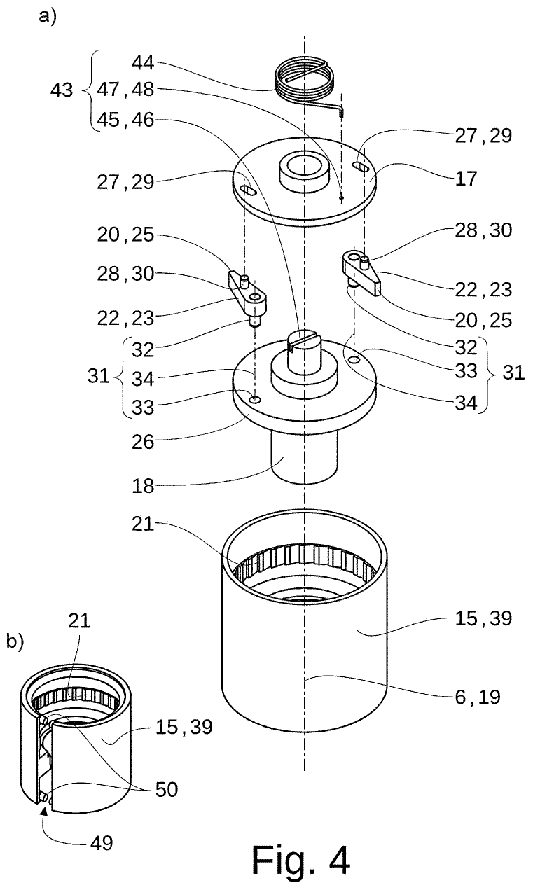

When the angular acceleration of the spindle 7 exceeds the predetermined threshold, the inertial body 17 is moved due to its own inertia from a starting position to a braking position relative to the spindle 7 in an inertial body rotational direction about the geometric spindle axis 6 (as shown in FIGS. 3, 4 and also FIGS. 5, 6, 7, 8) and optionally in an inertial body axial direction parallel to the geometric spindle axis 6 (FIGS. 5, 6), thereby activating the switchable braking device 16 and causing the rotational movement of the spindle 7 to be braked. Preferably, when the spindle 7 is set into rotation, the inertial body 17 is displaced less or not at all from the initial position towards the braking position when the angular acceleration of the spindle 7 is below the predetermined threshold value in the direction of rotation of the inertial body and, if applicable, in the axial direction of the inertial body, thereby keeping the switchable braking device 16 deactivated.

The “inertial body rotation direction” describes the direction in which the inertial body 17 rotates relative to the spindle 7. This direction results from the rotational movement of the inertial body 17 about the geometric spindle axis 6. The “inertial body axial direction,” on the other hand, indicates the direction of movement of the inertial body 17 along the geometric spindle axis 6, i.e., parallel to the axis of the spindle 7.

The terms “starting position” and “braking position” refer to the specific angular positions of the inertial body 17 relative to the spindle 7. During the starting position, the switchable braking device 16 remains inactive (deactivated), while, in the braking position, the braking device 16 is activated, to brake the rotary movement of the spindle 7.

The inertial body 17 therefore accelerates when the spindle 7 accelerates, i.e., its angular velocity increases, but, due to inertia, not necessarily to the same extent as the spindle 7 but usually more slowly, which results in a displacement of the inertial body 17 relative to the spindle 7 about and possibly along the geometric spindle axis 6. If the angular acceleration of the spindle 7 exceeds the stated threshold value, the inertial body 17 is displaced so strongly that it moves to its braking position. In the braking position, the inertial body 17 causes the activation of the braking device 16. This can be done in different ways, explained below using two examples.

Here, the braking device 16 preferably has a brake shaft 18 that is coaxial with the spindle 7, which shaft is coupled to the spindle 7 in a rotationally fixed and, in particular, axially fixed manner and introduces a braking torque into the spindle 7 when the braking device 16 is activated. The inertial body 17 is axially mounted on the brake shaft 18 and is rotatable relative to the brake shaft 18 about the geometric spindle axis 6. The brake shaft 18 thus rotates about an associated geometric brake shaft axis 19 which runs coaxially with the geometric spindle axis 6.

The term “coupled” is to be understood broadly in the present context. It relates not only to the direct drive-related coupling with the spindle 7, but also to an indirect coupling via one or more further torque-transmitting components. The brake shaft 18 can also be made in one piece with the spindle 7.

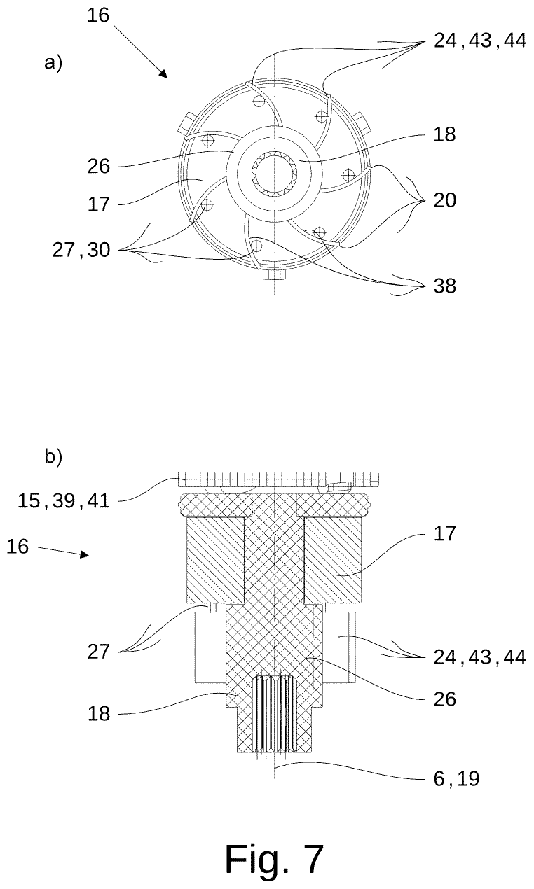

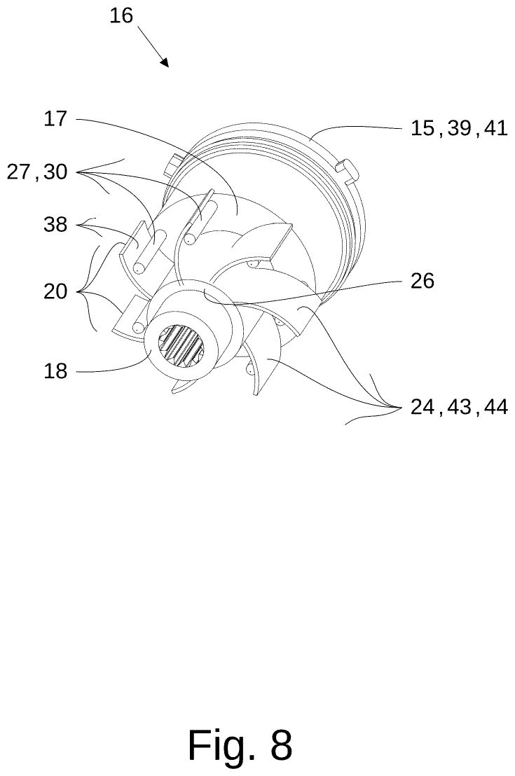

In the exemplary embodiment shown in FIGS. 3 and 4 and in the exemplary embodiment shown in FIGS. 7 and 8, it is preferably provided that the inertial body 17 be mounted on the brake shaft 18 in a manner that allows rotational movement only. The inertial body 17 is here preferably displaced on the brake shaft 18, by inertia, relative to the brake shaft 18 exclusively in the direction of rotation of the inertial body about the geometric spindle axis 6 into the braking position when the angular acceleration of the spindle 7 exceeds the predetermined threshold value.

In the exemplary embodiment shown in FIGS. 5 and 6, in contrast, the inertial body 17 is preferably mounted on the brake shaft 18, in particular via a screw engagement, so as to be rotatable and axially movable. In this case, it is preferably the case that, when the angular acceleration of the spindle 7 exceeds the predetermined threshold value, the inertial body 17 on the brake shaft 18 is displaced into the braking position, due to inertia, relative to the brake shaft 18 in the inertial body rotational direction about the geometric spindle axis 6 and in the inertial body axial direction parallel to the geometric spindle axis 6.

This allows the displacement of the inertial body 17 relative to the spindle 7 to its braking position, either exclusively in the inertial body rotation direction about the geometric spindle axis 6 (FIGS. 3 and 4, FIGS. 7 and 8) or, in particular simultaneously, in the inertial body rotation direction about the geometric spindle axis 6 and in the inertial body axial direction parallel to the geometric spindle axis 6 (FIGS. 5 and 6).

In the exemplary embodiment shown in FIGS. 3 and 4 and the exemplary embodiment shown in FIGS. 7 and 8, it is preferably provided that the braking device 16 have a radial brake contour 20 and a radial brake counter-contour 21 interacting with it, and that, when the braking device 16 is activated, the radial brake contour 20 and the radial brake counter-contour 21 be in radial frictional engagement with each other with a first frictional force or in radial blocking engagement with each other, and, when the braking device 16 is not activated, they be out of engagement or in radial frictional engagement with each other with a second frictional force that is smaller than the first frictional force.

In the exemplary embodiment shown in FIGS. 5 and 6, the braking device 16 preferably has an axial brake contour 20 and a brake counter-contour 21 axially interacting therewith, and, when the braking device 16 is activated, the axial brake contour 20 and the axial brake counter-contour 21 are in axial frictional engagement with each other with a first frictional force or in axial blocking engagement with each other, and, when the braking device 16 is not activated, are out of engagement or are in axial frictional engagement with each other with a second frictional force that is smaller than the first frictional force.

In this context, “interacting” means that the brake contour 20 and the brake counter-contour 21 are designed in such a way that they stand in relation to each other and can interact with each other. This means that they influence each other through physical forces such as friction or blocking, depending upon whether the braking device 16 is activated or deactivated. In the activated state, the two contours engage radially (FIGS. 3 and 4, FIGS. 7 and 8) or axially (FIGS. 5 and 6) with each other and generate a first, stronger frictional force or a blocking to brake the rotational movement. In the deactivated state, they either are not engaged at all (i.e., are not in contact) or are only in frictional contact with a smaller, second frictional force. The interaction thus describes the mechanical interaction between the two contours, by which the braking effect is regulated depending upon the operating state.

A “frictional engagement” is a state in which two surfaces—in this case the axial brake contour 20 and the axial brake counter-contour 21—are in contact with each other and brake a movement through frictional forces, possibly to the point of complete blocking of the movement. The strength of the friction depends upon the materials involved, the surface texture, and the force applied.

In contrast, a “blocking engagement” describes a state in which the two surfaces interlock in a form-fitting manner, so that no relative movement between them is possible. This always leads to a complete blockage of movement-for example, by interlocking teeth or special structures.

The state “out of engagement” means that the two surfaces are not in contact with each other, either through friction or through a mechanical blockage. In this case, there is no braking of the movement.

As will be explained in more detail below, the brake contour 20 is assigned to the spindle 7, and the brake counter-contour 21 is assigned to the outer housing 12, in particular to the first housing tube 13. This means that the brake contour 20 moves relative to the brake counter-contour 21 because the spindle 7 moves relative to the outer housing 12, in particular the first housing tube 13. Accordingly, here, the brake contour 20 moves rotationally relative to the brake counter-contour 21.

Furthermore, it is preferably provided here that the brake contour 20 and/or the relevant brake counter-contour 21 be formed by a friction lining or, as in the illustrated exemplary embodiments, by a tooth profile—here, preferably a locking tooth profile.

As can be clearly seen in FIGS. 4 to 6, a “locking tooth profile” is a tooth profile in which the teeth can only be overcome in one direction, and a blocking occurs in the other direction. The teeth are shaped in such a way that they have a steeper flank on the blocking side (rear side) and a flatter flank on the free-running side.

In the exemplary embodiment shown in FIGS. 3 and 4, the brake shaft 18 preferably has at least one brake element 22, which forms the relevant brake contour 20. Here, preferably two brake elements 22 are provided, in particular at diametrically opposite positions with respect to the geometric spindle axis 6. Each brake element 22 thus forms a brake contour 20. Preferably, as shown here, a plurality of brake elements 22 are provided, each of which forms a brake contour 20. Here, preferably the brake element 22 is a pivoting pawl 23. According to another embodiment, not shown here, a linearly displaceable slide is also conceivable as a brake element 22, either alternatively or additionally. According to yet another embodiment, to be explained further with reference to FIGS. 7 and 8, alternatively or additionally an elastic spring 24 that is elastically deformable by bending is also conceivable as a brake element 22. In this case, preferably, as can be clearly seen in FIG. 4a), one end 25 of the pawl 23 or of the slide, which is brought and/or can be brought into frictional or blocking engagement with the brake counter-contour 21, forms the brake contour 20.

The brake element 22, here in particular said pawl 23, or alternatively said slider, here preferably has a radial brake contour 20 which interacts with a radial brake counter-contour 21. The pivotable pawl 23 is in particular pivoted radially; that is, the end of the pawl 23 furthest from the geometric pivot axis (tip of the pawl 23) moves away from the geometric spindle axis 6 in order to activate the braking device 16. The geometric pivot axis of the pawl 23 here runs in particular parallel to the geometric spindle axis 6. A linearly displaceable slide (not provided here, but conceivable as an alternative to the pawl 23) is displaced in particular radially; that is, the radially outwardly directed end of the slide moves away from the geometric spindle axis 6 in order to activate the braking device 16.

Furthermore, here and in the exemplary embodiment shown in FIGS. 3 and 4, it is preferably provided that the brake element 22, here in particular said pawl 23, alternatively said slide, be mounted on a support structure 26, in particular a support plate, which is a component of the brake shaft 18 and here is formed by a radially projecting shoulder, in particular a circumferential collar, so as to be movable between an initial position, in which the brake element 22 is out of engagement with the brake counter-contour 21 via the brake contour 20, or is in frictional engagement with the second frictional force, which is smaller than the first frictional force, and an engagement position in which the brake element 22 is in frictional engagement or in blocking engagement with the brake counter-contour 21 via the brake contour 20.

The “initial position” and the “engagement position” are, here and in the following, positions of the brake element 22 relative to the brake shaft 18.

The brake element 22, here in particular said pawl 23, or alternatively said slide, here preferably has a guide counter-contour 28 movably guided in or on a guide contour 27 of the inertial body 17. As shown in FIG. 4a), the guide contour 27 is formed here by an elongated hole 29 or a groove in the inertial body 17, and/or the guide counter-contour 28 is formed by a protruding guide projection 30 on the brake element 22.

The brake element 22 in the form of the pawl 23 is here preferably supported axially on the support structure 26 and/or axially between the support structure 26 and the inertial body 17 via a brake element bearing 31—here, a pivot bearing. A brake element bearing shaft 32 of the brake element 22 here engages in an associated brake element bearing opening 33 on the support structure 26 and, if applicable, on the inertial body 17, thereby defining a brake element bearing axis 34 about which the brake element 22 can be pivoted between the initial position and the engagement position.

Preferably, in the exemplary embodiment shown in FIGS. 3 and 4, a rotary displacement of the inertial body 17 from its initial position to its braking position causes a movement of the brake element 22, a pivoting movement in the case of said pawl 23 and a linear movement in the case of said slider, from its initial position to its engagement position. The inertial body 17, in particular the guide contour 27 of the inertial body 17, preferably drives the brake element 22, in particular via the guide projection 30 of the brake element 22, from its initial position to its engagement position.

In the exemplary embodiment shown in FIGS. 5 and 6, the brake shaft 18 has a brake element 22, in particular designed to rotate about the geometric spindle axis 6, which forms the brake contour 20. Preferably, as shown here, exactly one brake element 22 is provided, which forms the brake contour 20. The brake element 22 is preferably formed here by a portion-here, an axial portion-of the inertial body 17. According to another embodiment, not shown here, a brake element 22 is also conceivable, alternatively or in addition, which is arranged in an axially fixed manner on the inertial body 17, in particular on an axial side of the inertial body 17. In this case, preferably, as can be clearly seen in FIG. 6, an annular portion 35 of the brake element 22 and/or inertial body 17, which is brought and/or can be brought into frictional or blocking engagement with the brake counter-contour 21, forms the brake contour 20.

The brake element 22, in particular said annular portion 35, or alternatively said brake element 22, which is axially fixed to the inertial body 17, preferably has here an axial brake contour 20 which interacts with an axial brake counter-contour 21. The brake element 22 or said annular portion 35 is displaced in particular axially; that is, the brake element 22 or said portion moves along the geometric spindle axis 6, in particular away from the spindle 7, in order to activate the braking device 16.

Furthermore, in the exemplary embodiment shown in FIGS. 5 and 6, it is preferably provided that the brake element 22, here in particular said annular portion 35, alternatively said brake element 22 axially fixed to the inertial body 17, be arranged concentrically to the brake shaft 18 and be mounted so as to be movable between an initial position, in which the brake element 22 is out of engagement with the brake counter-contour 21 via the brake contour 20 or in frictional engagement with the second frictional force, which is smaller than the first frictional force, and an engagement position in which the brake element 22 is in frictional engagement or in blocking engagement with the brake counter-contour 21 via the brake contour 20.

In the initial position, here, the brake element 22 and/or the inertial body 17 is preferably supported axially on a support structure 26, in particular a support plate, which is a component of the brake shaft 18 and is formed here by a radially projecting shoulder, in particular a circumferential collar. In the engagement position, the brake element 22 and/or the inertial body 17 is preferably axially spaced from the support structure 26.

The brake element 22, in particular said annular portion 35, alternatively said brake element 22 axially fixed to the inertial body 17, and/or the inertial body 17, is here preferably in meshing engagement with the brake shaft 18. As shown in FIG. 6, the brake element 22 and/or the inertial body 17 preferably has an internal thread 36 and the brake shaft 18 preferably has a corresponding external thread 37, so that a screw movement between these components is possible.

The brake element 22 in the form of the annular portion 35 is here preferably axially mounted on the brake shaft 18 via a brake element bearing 31—here, a screw motion bearing (threaded bearing). In the specific present case, the brake element 22 is in this manner mounted on the brake shaft 18 via the inertial body 17. A brake element bearing shaft 32 with an external thread 37 which is a component of the brake shaft 18 engages in an associated brake element bearing opening 33 with a corresponding internal thread 36, which is provided on the inertial body 17, thereby defining a brake element bearing axis 34 along which the brake element 22, performing a screw movement, can be linearly displaced-here, between the initial position and the engagement position.

Preferably, in the exemplary embodiment shown in FIGS. 5 and 6, an axial displacement of the inertial body 17 from its initial position to its braking position causes a movement of the brake element 22, in particular a parallel movement and/or screw movement, from its initial position to its engagement position.

In the exemplary embodiment shown in FIGS. 7 and 8, the brake shaft 18 preferably also has at least one brake element 22 which forms the respective brake contour 20. Here, preferably a plurality of brake elements 22, e.g., seven, are provided, in particular evenly distributed around the geometric spindle axis 6. Each brake element 22 also forms a brake contour 20 here. Preferably, as shown here, a plurality of brake elements 22 are provided, each of which forms a brake contour 20. Here, preferably the brake element 22 is a bending spring 24, in particular a plate-shaped or rod-shaped spring which is elastically deformable—here, a spring sheet, i.e., an element which is curved or bent in an initial position and deforms elastically under load and straighten when doing so. Preferably, an end 25 of the bending spring 24, which is brought and/or can be brought into frictional or blocking engagement with the brake counter-contour 21, forms the brake contour 20.

In the present connection, the term “straightening” refers to a change in shape of the bending spring 24 caused by bending elastic deformation, in which the spring transitions from a curved or bent initial position to a more stretched position. The straightening movement increases the extension of the bending spring 24 in the radial direction, i.e., in the direction from the geometric spindle axis 6 to the brake counter-contour 21, while its curvature or its bending angle decreases.

The brake element 22 in the form of the bending spring 24 here preferably has a radial brake contour 20 which interacts with a radial brake counter-contour 21. The bending spring 24 deformable by elastic bending is stretched radially; that is, the end of the bending spring 24 furthest from the geometric pivot axis (tip of the bending spring 24) moves away from the geometric spindle axis 6 to activate the braking device 16. The curvature and/or the bending axis of the bending spring 24 runs in particular parallel to the geometric spindle axis 6.

In the exemplary embodiment shown in FIGS. 7 and 8, it is also preferably provided that the brake element 22, here the bending spring 24, be arranged on a support structure 26 which is a component of the brake shaft 18. Each brake element 22 is fixed to the support structure 26, in particular in a stationary position, and is elastically deformable between an initial position, in which the brake element 22 is out of engagement with the brake counter-contour 21 via the brake contour 20 or is in frictional engagement with the second frictional force, which is smaller than the first frictional force, and an engagement position in which the brake element 22 is in frictional engagement or in blocking engagement with the brake counter-contour 21 via the brake contour 20.

In this connection, the “initial position” and the “engagement position” are also positions of the brake element 22 relative to the brake shaft 18. The initial position corresponds to the aforementioned curved or bent starting position, and the engagement position corresponds to the more stretched position.

The brake element 22 according to FIGS. 7 and 8, here the said bending spring 24, preferably has a guide counter-contour 28 which is movably guided on a guide contour 27 of the inertial body 17. As shown in FIGS. 7a and 8, the guide contour 27 is formed here by a protruding guide projection 30 on the inertial body 17, and/or the guide counter-contour 28 is formed by a guide surface 38 or guide edge on the brake element 22.

Preferably, in the exemplary embodiment shown in FIGS. 7 and 8, a rotational displacement of the inertial body 17 from its initial position to its braking position causes a bending elastic deformation of the brake element 22 from its initial position to its engagement position. The inertial body 17, in particular the relevant guide projection 30 of the inertial body 17, preferably drives the corresponding brake element 22, in particular via the guide surface 38 of the brake element 22, from its initial position to its engagement position.

In the exemplary embodiments shown here and which are preferred in this respect, it is also preferably the case that the brake counter-contour 21 is formed as shown here on a brake housing 39 of the braking device 16 or on the outer housing 12, in particular on the first housing tube 13. When a brake housing 39 is present, i.e., a component that at least radially surrounds the components of the braking device 16 which move during a braking process, this forms the housing-bound component 15. Here, the brake housing 39 is preferably connected to the outer housing 12, in particular the first housing tube 13, so as to be rotationally movable in the event of overload; that is, when a torque between the brake housing 39 and the outer housing 12 exceeds a predetermined threshold value, this causes the brake housing 39 to slip relative to the outer housing 12. This has the advantage that, if the predetermined torque is exceeded, no permanent damage or deformation of the components involved occurs. Instead, the rotationally movable connection between the brake housing 39 and the outer housing 12 allows a controlled slippage, thereby reducing excessive loads.

In order to enable the aforementioned slippage of the housing-bound component 15 or brake housing 39 relative to the outer housing 12 when the predetermined torque threshold is exceeded, various designs of the component 15 or brake housing 39 and various connection types are conceivable. Here, the component 15 or brake housing 39 and/or the outer housing 12 is preferably made of a plastic material, but can also be made of metal.

Firstly, the component 15 or brake housing 39, as shown in FIG. 4a), can be cylindrical and in particular closed all the way around. In this case, the component 15 or brake housing 39 is in particular inserted and/or pressed into the outer housing 12 (press-fit). The component 15 or brake housing 39 can also be provided with an axial slot 49, as shown in FIG. 4b), i.e., can be C-shaped, wherein it is then in particular inserted into the outer housing 12, in particular in a spring-loaded manner with more spring force than is needed. The spring action provided for this purpose is provided, for example, by the material-related, inherent bending elasticity of the component 15 or brake housing 39 and/or by at least one additional spring element inserted into the component 15 or brake housing 39, in particular made of metal, e.g., as in FIG. 4b), a C-shaped sheet metal clamp 50, or alternatively a compression spring.

The interface to the outer housing 12 can have a wave contour, rounded ribs, a tooth contour, a trapezoidal contour, or the like on the radial outside of the component 15 or brake housing 39 and/or the radial inside of the outer housing 12, in addition to or as an alternative to the presence of a press-fit. Individually spring-loaded lugs on the radial outer side of component 15 or brake housing 39 and/or the radial inner side of the outer housing 12 are also conceivable, which engage in an undercut on the corresponding other component (component 15 or brake housing 39 or outer housing 12) to which they are joined.

In principle, however, a rotationally fixed connection of the brake housing 39 to the outer housing 12, in particular the first housing tube 13, is also conceivable.

The brake counter-contour 21 can be formed, as in FIGS. 3 and 4, on a tubular, in particular cylindrical, brake housing part 40, in particular radially on the inside, or, as in FIGS. 5 and 6, on a brake housing cover 41 which is axially placed on such a tubular brake housing part 40 or is axially inserted into such a tubular brake housing part 40. Here and in FIGS. 5 and 6, the brake housing cover 41 preferably has a brake shaft opening 42 through which the brake shaft 18 is axially passed. In the exemplary embodiment shown in FIGS. 7 and 8, the brake counter-contour 21 is also formed radially on the inside of a tubular, in particular cylindrical, brake housing part 40 (not shown here). Here and preferably, only the brake housing cover 41 of the brake housing 39 is shown, which here is preferably axially placed onto the tubular brake housing part 40 or is axially inserted into the tubular brake housing part 40. In principle, however, a brake housing 39 not having a brake housing cover is also conceivable, in particular in the case in which, as in FIGS. 3 and 4, the inertial body 17 axially covers the majority of the radial cross-section of the brake housing 39.

Finally, in all exemplary embodiments, it is preferably provided that the braking device 16 have a return arrangement 43 for the inertial body 17, which returns the inertial body 17 to the initial position as soon as the angular acceleration of the spindle 7 decreases. Thus, as the angular acceleration of the spindle 7 increases, the inertial body 17 is continuously moved further towards its braking position and, by means of the return arrangement 43, is moved in the opposite direction with decreasing angular acceleration of the spindle 7, at least until the inertial body 17 has reached its braking position, and the corresponding brake element 22 has entered its engagement position.

Once the braking device 16 has been activated, it is preferably the case that the corresponding brake element 22 is fixed in its engagement position and, consequently, the inertial body 17 is fixed in its braking position. Despite the presence of a return arrangement 43, the brake element 22 does not automatically return to its initial position and the inertial body 17 does not automatically return to its starting position when the angular acceleration of the spindle 7 is again below the said threshold value and in particular is zero. Rather, in this case it is necessary to first at least loosen the engagement between the brake contour 20 and the brake counter-contour 21, in particular by external force and/or manually by an operator-for example, by lifting the previously sagged closure element 2. Only then can the return mechanism 43 return the inertial body 17 to its initial position, thereby also returning the brake element 22 completely to its initial position.

Here, the return arrangement 43 preferably has a return spring 44—according to the exemplary embodiments in FIGS. 3 to 6, a return spring 44 separate from the brake element 22—here in the form of a torsion spring, which exerts a return force on the inertial body 17 in the direction of its initial position. This means that the inertial body 17 is moved towards its braking position against the return force to activate the braking device 16. The return spring 44 is here, and preferably in all exemplary embodiments, pre-tensioned between the brake shaft 18 and the inertial body 17.

According to FIGS. 4 and 6, in both exemplary embodiments, the return spring 44 is fixed both to the brake shaft 18 and to the inertial body 17. For this purpose, a first spring mounting point 45, here a central spring mounting groove 46, is preferably provided on the brake shaft 18, and a second spring mounting point 47, here a spring mounting hole 48 eccentric to the geometric spindle axis 6, is preferably provided on the inertial body 17.

In the exemplary embodiment according to FIGS. 7 and 8, the return arrangement 43 also has a return spring 44, here preferably even a plurality of return springs 44 that are in particular identical in design, in order to exert a return force on the inertial body 17 in the direction of its initial position. Here, however, each return spring 44 is not a separate return spring 44 from the brake element 22; rather, each return spring 44 is formed by a brake element 22—here, a bending spring 24. The return spring 44 is here preferably fixed only to the brake shaft 18 and not to the inertial body 17, although the latter is also conceivable in principle.

According to FIGS. 3 and 4, it is preferably the case that a rotational return of the inertial body 17 to its initial position causes a movement of the brake element 22, in the case of said pawl 23 a pivoting movement and in the case of said slide a linear movement, to its initial position. Here, the inertial body 17, in particular the guide contour 27 of the inertial body 17, preferably drives the brake element 22, in particular via the guide projection 30 of the brake element 22, into its initial position. As shown in FIGS. 5 and 6, it is preferably the case that an axial return of the inertial body 17 to its initial position causes a movement of the brake element 22, in particular a movement and/or screwing movement parallel thereto, to its initial position. As shown in FIGS. 7 and 8, a rotational return of the inertial body 17 to its initial position preferably causes an elastic deformation of the return spring 44 and, accordingly, of the brake element 22, here the bending spring 24, back to the initial position. Here, the relevant guide projection 30 of the inertial body 17 preferably drives the brake element 22 into the initial position via the guide surface 38.

Here, the return arrangement 43 also contributes to there being a transmission of torque from the spindle 7 to the inertial body 17, viz., via the elastic coupling between the spindle 7 and the inertial body 17. The magnitude of the transmitted torque depends, among other things, upon the spring stiffness of the return spring 44 or bending spring 24 that produces the elastic coupling and upon the magnitude of the angular acceleration of the spindle 7. As already explained, the friction, in particular static friction, between the spindle 7 and the inertial body 17 also affects the magnitude of the transmitted torque.

According to a further teaching, a drive arrangement 1 for a closure element 2, in particular a tailgate, of a motor vehicle 3 is proposed, having a proposed spindle arrangement 4 and a motor drive for displacing the closure element 2, in particular a spindle drive.

The spindle drive preferably has a drive motor and, like the proposed motorless spindle arrangement 4, a spindle-spindle nut drive 5 downstream of the motor in terms of drive, with a spindle 7, having an axially extending geometric spindle axis 6, and a spindle nut 8 meshing therewith for performing, in particular, linear drive movements along the geometric spindle axis 6 between a spindle-side connection 9 and a spindle-nut-side connection 10. Here as well, the spindle 7 is axially fixedly coupled to the spindle-side connection 9, and the spindle nut 8 is axially fixedly connected to a spindle guide tube 11, which is axially fixedly coupled to the spindle-nut-side connection 10.

What is claimed is:

1. A spindle arrangement for a closure element, in particular a tailgate, of a motor vehicle, wherein the spindle arrangement has a spindle-spindle nut drive with a spindle, having an axially extending geometric spindle axis, and a spindle nut meshing therewith for performing, in particular, linear displacement movements along the geometric spindle axis between a spindle-side connection and a spindle-nut-side connection, wherein the spindle is axially fixedly coupled to the spindle-side connection and the spindle nut is axially fixedly connected to a spindle guide tube, which is axially fixedly coupled to the spindle-nut-side connection,
wherein the spindle arrangement has a tubular outer housing, radially enclosing the spindle-spindle nut drive, with a first housing tube, in particular housing outer tube, and optionally a second housing tube, in particular housing inner tube, which is capable of telescoping with the first housing tube, wherein during a rotational movement of the spindle relative to the outer housing or to a housing-bound component in at least one spindle rotation direction, if the angular acceleration of the spindle relative to the outer housing or housing-bound component exceeds a predetermined threshold value, a switchable braking device is activated, which causes a braking of the rotational movement of the spindle.

2. The spindle arrangement according to claim 1, wherein the braking device has an inertial body that is connected to the spindle via a torque-transmitting coupling and is rotatable about the geometric spindle axis relative to the spindle, which body, when the angular acceleration of the spindle exceeds the predetermined threshold value, is displaced, due to inertia, relative to the spindle from a starting position to a braking position in an inertial body rotation direction about the geometric spindle axis and, optionally, in an inertial body axial direction parallel to the geometric spindle axis, whereby the switchable braking device is activated, preferably that, when the spindle is set into rotation, when there is an angular acceleration of the spindle that is below the predetermined threshold value in the inertial body rotation direction and optionally in the inertial body axial direction, the inertial body is displaced less or not at all from the starting position towards the braking position, as a result of which the switchable braking device remains deactivated.

3. The spindle arrangement according to claim 2, wherein the braking device has a brake shaft coaxial with the spindle, which is rotationally fixed and in particular axially fixed to the spindle and introduces a braking torque into the spindle when the braking device is activated, and that the inertial body is axially mounted on the brake shaft and is rotatable about the geometric spindle axis relative to the brake shaft.

4. The spindle arrangement according to claim 3, wherein the inertial body is mounted on the brake shaft exclusively so as to be capable of rotational movement, preferably that, when the angular acceleration of the spindle exceeds the predetermined threshold value, the inertial body on the brake shaft is displaced into the braking position, due to inertia, relative to the brake shaft exclusively in the direction of rotation of the inertial body about the geometric spindle axis, or that the inertial body is mounted on the brake shaft, in particular via a threaded engagement, so as to be rotatable and axially movable, preferably that, when the angular acceleration of the spindle exceeds the predetermined threshold value, the inertial body on the brake shaft is displaced into the braking position, due to inertia, relative to the brake shaft in the direction of rotation of the inertial body about the geometric spindle axis and in the axial direction of the inertial body parallel to the geometric spindle axis.

5. The spindle arrangement according to claim 1, wherein the braking device has a radial brake contour and a radial brake counter-contour interacting therewith, and that, when the braking device is activated, the radial brake contour and the radial brake counter-contour are in frictional engagement radially with each other with a first frictional force or in blocking engagement radially with each other, and, when the braking device is not activated, are out of engagement or are in frictional engagement radially with each other with a second frictional force that is smaller than the first frictional force, or that the braking device has an axial brake contour and an axial brake counter-contour interacting therewith, and that, when the braking device is activated, the axial brake contour and the axially interacting brake counter-contour are in frictional engagement axially with each other with a first frictional force or in axially blocking engagement with each other, and, when the braking device is not activated, are out of engagement or in frictional engagement axially with each other with a second frictional force that is smaller than the first frictional force.

6. The spindle arrangement according to claim 5, wherein each brake contour and/or the corresponding brake counter-contour is formed by a friction lining or a tooth profile, in particular a locking tooth profile.

7. The spindle arrangement according to claim 5, wherein the brake shaft has at least one brake element which forms the relevant brake contour, preferably that the brake element is a pivotable pawl or a linearly displaceable slide or a bending spring which is elastically deformable by bending, further preferably that one end of the pawl or of the slide or of the bending spring, which is brought and/or can be brought into frictional or blocking engagement with the brake counter-contour, forms the brake contour.

8. The spindle arrangement according to claim 7, wherein the brake element is movably mounted and/or elastically deformable on a support structure, in particular a support plate, which is a component of the brake shaft, between an initial position, in which the brake element is out of engagement with the brake counter-contour via the brake contour or is in frictional engagement with the second frictional force, which is smaller than the first frictional force, and an engagement position in which the brake element is in frictional engagement or in blocking engagement with the brake counter-contour via the brake contour with the first frictional force.

9. The spindle arrangement according to claim 7, wherein the brake element has a guide counter-contour movably guided in or on a guide contour of the inertial body, preferably that the guide contour is formed by an elongated hole or a groove in the inertial body and/or the guide counter-contour is formed by a projecting guide projection on the brake element, or that the guide contour is formed by a projecting guide projection on the inertial body and/or the guide counter-contour is formed by a guide surface or guide edge on the brake element.

10. The spindle arrangement according to claim 7, wherein a rotary displacement of the inertial body from its initial position to its braking position causes a movement and/or bending elastic deformation of the brake element from its initial position to its engagement position, preferably that the inertial body, in particular the guide contour of the inertial body, drives the brake element, in particular via the guide projection of the brake element, from its initial position to its engagement position.

11. The spindle arrangement according to claim 5, wherein the brake shaft has a brake element, in particular running around the geometric spindle axis, which forms the brake contour, preferably that the brake element is formed by a portion, in particular an axial portion, of the inertial body or is arranged axially fixed on the inertial body, in particular on an axial side of the inertial body, further preferably that an annular portion of the brake element and/or of the inertial body, which is brought and/or can be brought into frictional or blocking engagement with the brake counter-contour, forms the brake contour.

12. The spindle arrangement according to claim 11, wherein the brake element is arranged concentrically to the brake shaft and is mounted so as to be movable between an initial position, in which the brake element is out of engagement with the brake counter-contour via the brake contour or is in frictional engagement with the second frictional force, which is smaller than the first frictional force, and an engagement position in which the brake element is in frictional engagement or in blocking engagement with the brake counter-contour via the brake contour.

13. The spindle arrangement according to claim 11, wherein the brake element and/or the inertial body is in meshing engagement with the brake shaft, preferably that the brake element and/or the inertial body has an internal thread and the brake shaft has a corresponding external thread.

14. The spindle arrangement according to claim 11, wherein an axial displacement of the inertial body from its initial position to its braking position causes a movement of the brake element from its initial position to its engagement position.

15. The spindle arrangement according to claim 5, wherein the brake counter-contour is formed on a brake housing of the braking device or on the outer housing, in particular on the first housing tube, preferably that the brake housing is connected to the outer housing, in particular the first housing tube, in a rotationally fixed manner or so as to be rotatable in the event of overload.

16. The spindle arrangement according to claim 2, wherein the braking device has a return arrangement for the inertial body which is configured to return the inertial body to its initial position, preferably that the return arrangement has a return spring which exerts a return force on the inertial body in the direction of its initial position, further preferably that the return spring is pre-tensioned between the brake shaft and the inertial body and/or is a return spring separate from the brake element or is a return spring formed by the brake element.

17. A drive arrangement for a closure element, in particular a tailgate, of a motor vehicle, having a spindle arrangement according to claim 1 and a motor drive for displacing the closure element, in particular a spindle drive.

18. The spindle arrangement according to claim 6, wherein the brake shaft has at least one brake element which forms the relevant brake contour, preferably that the brake element is a pivotable pawl or a linearly displaceable slide or a bending spring which is elastically deformable by bending, further preferably that one end of the pawl or of the slide or of the bending spring, which is brought and/or can be brought into frictional or blocking engagement with the brake counter-contour, forms the brake contour.

19. The spindle arrangement according to claim 8, wherein the brake element has a guide counter-contour movably guided in or on a guide contour of the inertial body, preferably that the guide contour is formed by an elongated hole or a groove in the inertial body and/or the guide counter-contour is formed by a projecting guide projection on the brake element, or that the guide contour is formed by a projecting guide projection on the inertial body and/or the guide counter-contour is formed by a guide surface or guide edge on the brake element.

20. The spindle arrangement according to claim 12, wherein the brake element and/or the inertial body is in meshing engagement with the brake shaft, preferably that the brake element and/or the inertial body has an internal thread and the brake shaft has a corresponding external thread.
